(19) United States
(12) Patent Application Publication
(10) Pub. No.: US 2015/0086765 A1
(43) Pub. Date: Mar. 26, 2015

(54) THIN FILM HETEROSTRUCTURES

(71) Applicant: INDIAN INSTITUTE OF TECHNOLOGY KANPUR, Kanpur (IN)

(72) Inventors: Ashish GARG, Uttar Pradesh (IN); Rajesh KATOCH, Uttar Pradesh (IN); Rajeev GUPTA, Uttar Pradesh (IN)

(21) Appl. No.: 14/496,452

(22) Filed: Sep. 25, 2014

(30) Foreign Application Priority Data
Sep. 25, 2013 (IN) 2842/DEL/2013

(51) Int. Cl. B05D 1/38; B05D 1/00

(52) U.S. Cl. CPC B05D 1/38; B05D 1/005
USPC 428/216; 428/336; 427/419.8; 427/372.2

(57) ABSTRACT

Bismuth ferrite-lead titanate heterostructures and methods for their preparation are disclosed. Heterostructures may include a metal coated substrate contacting a first ferroelectric layer made of lead titanate; and a second ferroelectric layer contacting the first ferroelectric layer, the second ferroelectric layer having the composition (BiFeO₃)₁₋ₓ—(PbTiO₃)ₓ, wherein 0.25≦x≦0.35.

### RELATED APPLICATION

This application claims priority benefit under Title 35 §119(a) of Indian Patent Application No. 2842/DEL/2013, filed Sep. 25, 2013, entitled, “Thin Film Hetero structures,” the contents of which are herein incorporated by reference.

### BACKGROUND

BiFeO₃ (bismuth ferrite, BF), a multiferroic oxide with a rhombohedrally distorted perovskite structure having space group R3c, exhibits high ferroelectric Curie temperature (T_{C}) at ˜1103 K². It also shows G-type antiferromagnetic behavior with Neel transition (T_{N}) at ˜643 K, with an incommensurate spiral magnetic ordering. Its high polarization (Pₛ˜100 μC/cm²) along (111) direction, large piezoelectric coupling coefficient (d₃₃ about 70 pC/N) coupled with high Tc makes it desirable for sensors, actuators and high density magnetoelectric random access memories (MERAMs). However, the valence fluctuations, such as reduction of Fe³⁺ to Fe²⁺, creation of oxygen vacancies for charge compensation, and the propensity to make secondary phases makes it highly conductive, thus hindering its practical utilization in devices.

The formation of solid solution of BF with ABO₃ perovskite oxides, such as PbTiO₃ (lead titanate, PT) enhances BF's insulation resistance. PT is a ferroelectric with a high T_{c} about 760K, and possess a large remnant polarization (Pᵣ about 60 μC/cm²), a large piezoelectric coupling coefficient (d₃₃ about 97 pC/N), and a very high electromechanical coupling coefficient (k about 0.8). It forms a continuous solid solution with BF and is represented by (BF)₁₋ₓ-(PT)ₓ (or bismuth ferrite-lead titanate, BF-PT), with the existence of a morphotropic phase boundary (MPB) at x=0.30 (weight %). The BF-PT system exhibits unusually high tetragonality (c/a about 1.187), high Curie temperature (T_{c} about 900K), and high piezoelectric activity, thus making it attractive for high temperature piezoelectric applications. However, for such applications, the BF-PT material needs to be deposited in the form of thin films of thicknesses typically lower than 1 micron. BF-PT thin films can be deposited using physical vapor process, as well as chemical solution process. However, films prepared by these processes show good ferroelectric response at temperatures lower than room temperature. Further, these processes are expensive and cannot be practically used for fabricating large devices. Hence, there is a need to develop methods for making BF-PT thin films with better properties. Such methods may be, for example, more cost effective and/or suitable for large area fabrication.

### SUMMARY

Disclosed herein are compositions of bismuth ferrite-lead titanate (BF-PT) thin films with excellent ferroelectric properties, as well as methods of making and using the same. In an embodiment, a method of making a heterostructure may involve: mixing a solution of a bismuth salt with a solution of a ferric acetylacetonate to obtain a bismuth ferrite solution; mixing a solution of a lead salt with a solution of a titanium compound to obtain a lead titanate solution; mixing the bismuth ferrite solution and the lead titanate solution to obtain a bismuth ferrite-lead titanate solution (BF-PT solution); contacting a substrate with the lead titanate solution to obtain a lead titanate coated substrate; and contacting the lead titanate coated substrate with the BF-PT solution to obtain the heterostructure.

In an additional embodiment, a heterostructure may include a metal coated silicon substrate contacting a first ferroelectric layer made of lead titanate; and a second ferroelectric layer contacting the first ferroelectric layer, the second ferroelectric layer having the composition (BiFeO₃)₁₋ₓ—(PbTiO₃)ₓ, wherein 0.25≦x≦0.35, wherein the thickness of the first ferroelectric layer is 30 nanometers, and the heterostructure has a dielectric constant of about 400 to about 1000, when measured at a temperature of about 20° C. to about 30° C. For example, these measurements can be made at 25° C.

In a further embodiment, an article may include a heterostructure having a metal coated silicon substrate contacting a first ferroelectric layer comprising lead titanate; and a second ferroelectric layer contacting the first ferroelectric layer, the second ferroelectric layer comprising (BiFeO₃)₁₋ₓ—(PbTiO₃)ₓ, wherein 0.25≦x≦0.35, wherein the thickness of the first ferroelectric layer is 30 nanometers, and the heterostructure has a dielectric constant of about 400 to about 1000, when measured at a temperature of about 20° C. to about 30° C. For example, these measurements can be made at 25° C.

In an additional embodiment, a lead titanate coating may include a bismuth ferrite-lead titanate compound, wherein the bismuth ferrite-lead titanate compound is represented by (BiFeO₃)₁₋ₓ—(PbTiO₃)ₓ, wherein 0.25≦x≦0.35.

### BRIEF DESCRIPTION OF THE FIGURES

FIG. 1 is an illustration of a heterostructure with first and second ferroelectric layers according to an embodiment.

FIG. 2 depicts various steps of making a BF-PT solution according to an embodiment.

FIG. 3 shows atomic force microscope surface morphology of BF-ₓPT films according to an embodiment; (a) x=0.35; (b) x=0.30; and (c) x=0.25.

FIG. 4 shows cross sectional scanning electron microscopy of a BF-ₓPT film (x=0.25) according to an embodiment.

FIG. 5 shows glancing incidence X-ray diffraction (GIXRD) patterns of BF-ₓPT films according to an embodiment.

FIG. 6 shows refined profiles of different compositions of BF-ₓPT thin films [(a) x=0.25; (b) x=0.30; and (c) x=0.35] using different space groups according to an embodiment.

FIG. 7A shows room temperature ferroelectric hysteresis loops of BF-ₓPT films at 1 kHz according to an embodiment; FIG. 7B shows ferroelectric hysteresis loops for BF-ₓPT films (x=0.25) as a function of frequency at room temperature according to an embodiment.

FIG. 8 shows variation of room temperature dielectric constant of BF-xPT films according to an embodiment.

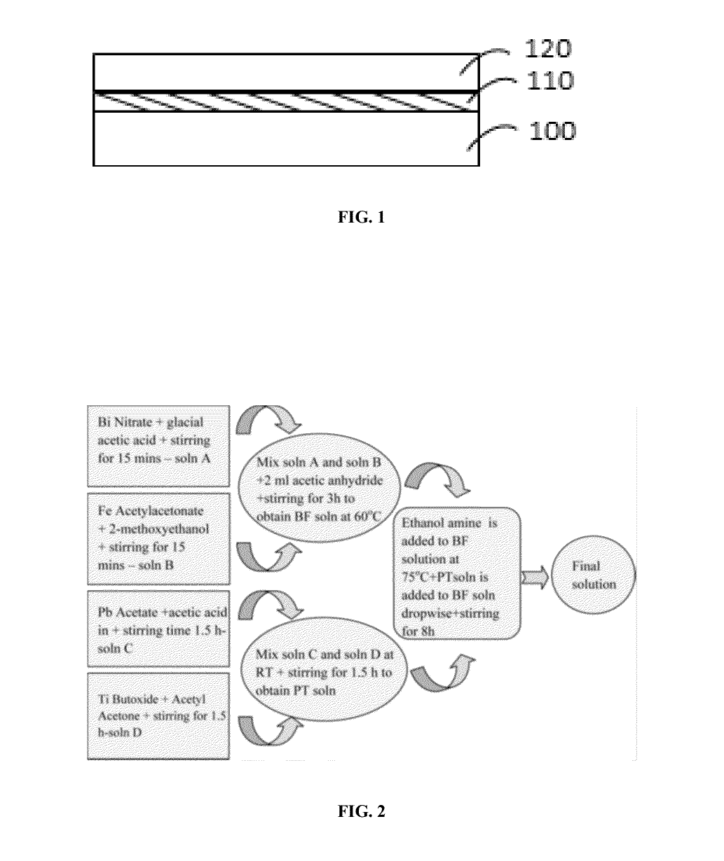

### DETAILED DESCRIPTION

This disclosure is not limited to the particular systems, devices and methods described, as these may vary. The terminology used in the description is for the purpose of describing the particular versions or embodiments only, and is not intended to limit the scope.

Disclosed herein are BF-PT containing heterostructures and methods for making these heterostructures. A representative example of a BF-PT heterostructure is illustrated in FIG. 1. A substrate 100 is coated with a lead-titanate layer (PT) 110 and serves as a template for the BF-PT layer 120. The substrate may be silicon, quartz, or single crystal oxide substrates, such as SrTiO₃, MgO, LaAlO₃, and NdGaO₃. Representative examples of silicon substrates include, but are not limited to, semiconductor materials, such as silicon, silicon oxide, silicon oxide/silicon, silicon nitride, silica on silicon, and the like. The silicon substrate is coated by a metal. Non-limiting examples of the metal include platinum, gold, iridium, palladium, osmium, silver, rhodium, ruthenium, lanthanum, strontium, or any combination thereof. The metal described herein may be elemental metal or metal compounds. Other examples include, but are not limited to, SrRuO₃, LaNiO₃, or any conducting metal oxide. The metal coating may be a partial coating on the silicon substrate. In some embodiments, the metal coating may completely surround the silicon substrate.

In some embodiments, the lead titanate (PT) layer 110 may be a partial coating on the substrate 100. In some embodiments, the PT layer may completely surround the substrate. The PT layer 110 may have thickness of about 25 nanometers to about 40 nanometers, about 25 nanometers to about 35 nanometers, about 25 nanometers to about 30 nanometers, about 30 nanometers to about 40 nanometers, or about 35 nanometers to about 40 nanometers. Specific examples include about 25 nanometers, about 30 nanometers, about 35 nanometers, about 40 nanometers, and ranges between any two of these values (including their endpoints). The PT layer 110 may help to promote the adhesion of the BF-PT layer 120 to the substrate during the coating stage. In addition, it may also enhance the ferroelectric properties by providing additional insulation at the interface between the BF-PT layer and the substrate, and may act as a barrier to the charge flow.

In some embodiments, the BF-PT layer 120 may partially or completely cover the underlying PT layer 110. In some embodiments, the BF-PT layer 120 may have a thickness of about 300 nanometers to about 400 nanometers, about 300 nanometers to about 350 nanometers, about 300 nanometers to about 320 nanometers, about 400 nanometers to about 350 nanometers, or about 400 nanometers to about 320 nanometers. Specific examples include about 300 nanometers, about 325 nanometers, about 350 nanometers, about 400 nanometers, and ranges between any two of these values (including their endpoints).

In some embodiments, the BF-PT layer composition may be represented by (BF)₁₋ₓ-(PT)ₓ, wherein 0.25≦x≦0.35. In other embodiments, the BF-PT layer composition may be represented by (BiFeO₃)₁₋ₓ—(PbTiO₃)ₓ, wherein 0.25≦x≦0.35. The BF-PT layer may be further characterized by its ferroelectric properties, including remnant polarization (Pᵣ), dielectric constant, fatigue, and electrical leakage. In some embodiments, the BF-PT layer 120 (or the heterostructure) may have a dielectric constant of about 400 to about 1000, about 400 to about 800, about 400 to about 600, about 400 to about 500, about 800 to about 1000, about 600 to about 1000, about 500 to about 1000, about 500 to about 800, or about 600 to about 800, when measured at a temperature of about 20° C. to about 30° C. For example, these measurements can be made at 25° C. Specific examples of dielectric constants include about 400, about 500, about 600, about 700, about 900, about 1000, and ranges between any two of these values (including their endpoints).

In some embodiments, the BF-PT layer (or the heterostructure) may have a remnant polarization of about 50 μC/cm² to about 90 μC/cm², about 50 μC/cm² to about 80 μC/cm², about 50 μC/cm² to about 70 μC/cm², about 50 μC/cm² to about 60 μC/cm², about 60 μC/cm² to about 90 μC/cm², about 60 μC/cm² to about 80 μC/cm², about 60 μC/cm² to about 70 μC/cm², or about 60 μC/cm² to about 70 μC/cm². Specific examples include about 50 μC/cm², about 60 μC/cm², about 70 μC/cm², about 90 μC/cm², and ranges between any two of these values (including their endpoints).

In some embodiments, the BF-PT layer may exhibit a single phase. In other embodiments, the BF-PT layer may contain multiple phases, such as two, three, or four phases. The BF-PT layer may have a grain size having an average diameter of about 50 nanometers to about 200 nanometers, about 50 nanometers to about 150 nanometers, about 50 nanometers to about 100 nanometers, about 50 nanometers to about 75 nanometers, about 150 nanometers to about 200 nanometers, about 100 nanometers to about 200 nanometers, about 75 nanometers to about 200 nanometers, or about 75 nanometers to about 100 nanometers. Specific examples include about 50 nanometers, about 100 nanometers, about 150 nanometers, about 200 nanometers, and ranges between any two of these values (including their endpoints).

In some embodiments, the BF-PT layer may have a tetragonal crystal structure, a monoclinic crystal structure, or any combination thereof. For example, for (BiFeO₃)₁₋ₓ—(PbTiO₃)ₓ, at x=0.25, monoclinic structure may be predominant. At x=0.30 and x=0.35, monoclinic and tetragonal structures may co-exist. These subtle structural changes may have significant repercussion in terms of properties, particularly ferroelectric polarization. Since monoclinic structure has more number of independent piezoelectric coupling coefficients, it may manifest into enhanced ferroelectricity.

The heterostructures described herein may exhibit excellent ferroelectric properties at room temperature. For example, the hysteresis loop of the heterostructures may show complete saturation (characterized by flattening at the highest field and change in the slope dP/dE across zero field), display less charge leakage, and stable high polarization due to co-existence of monoclinic and tetragonal phases. Such heterostructures find wide applications in, for example, memory devices, piezoelectric sensors, actuators, transducers, or any combination thereof.

In some embodiments, a method of making a heterostructure may include: mixing a solution of a bismuth salt with a solution of a ferric acetylacetonate to obtain a bismuth ferrite solution (BF solution); mixing a solution of a lead salt with a solution of a titanium compound to obtain a lead titanate solution (PT solution); mixing the bismuth ferrite solution and the lead titanate solution to obtain bismuth ferrite-lead titanate solution (BF-PT solution); contacting a substrate with the lead titanate solution to obtain a lead titanate coated substrate; and contacting the lead titanate coated substrate with the BF-PT solution to obtain the hetero structure.

Non-limiting examples of bismuth salt that may be used are bismuth nitrate, bismuth chloride, bismuth sulfate, bismuth phosphate, bismuth acetate, bismuth citrate, bismuth alkoxide, or any combination thereof. In some embodiments, the bismuth salts described herein may be dissolved in a solvent chosen from, for example, acetic acid, formic acid, oxalic acid, trichloroacetic acid, and 2-methoxyethanol, or any combination thereof, to obtain the bismuth salt solution.

In some embodiments, ferric acetylacetonate may be dissolved in a solvent chosen from, for example, 2-methoxyethanol, an ethylene glycol alkyl ether, an ethylene glycol dialkyl ether, and an ethylene glycol ester, or any combination thereof, to obtain the ferric acetylacetonate solution.

In some embodiments, the bismuth salt solution and the ferric acetylacetonate solution may be mixed in the presence of an acid anhydride. Non-limiting examples of acid anhydrides include acetic anhydride, maleic anhydride, propionic anhydride, and succinic anhydride, or any combination thereof. To obtain the BF solution, the bismuth salt solution and the ferric acetylacetonate solution may be mixed for about 1 hour to about 6 hours, about 1 hour to about 4 hours, about 1 hour to about 3 hours, or about 1 hour to about 2 hours. Specific examples include about 1 hour, about 2 hours, about 3 hours, about 4 hours, about 6 hours, and ranges between any two of these values (including their endpoints). Suitable temperatures for mixing include about 40° C. to about 70° C., about 40° C. to about 60° C., or about 40° C. to about 45° C. Specific examples include about 40° C., about 50° C., about 60° C., about 70° C., and ranges between any two of these values (including their endpoints).

In some embodiments, the lead salt may be, for example, lead acetate, lead phosphate, lead sulfate, or lead nitrate, or any combination thereof. The lead salt described herein may be dissolved in a solvent chosen from, for example, acetic acid, formic acid, oxalic acid, trichloroacetic acid, and citric acid, or any combination thereof, to obtain the lead salt solution.

In some embodiments, the titanium compound may be, for example, a titanium alkoxide. Suitable titanium alkoxides include, but are not limited to, titanium isopropoxide, titanium butoxide such as titanium n-butoxide, titanium methoxide, titanium ethoxide, any titanium n-propoxide, or any mixture thereof. In some embodiments, the titanium compound may be dissolved in a solvent such as, for example, acetylacetone, to obtain the titanium compound solution.

In some embodiments, to obtain the PT solution, the lead salt solution and the titanium compound solution may be mixed for about 30 minutes to about 3 hours, about 30 minutes to about 2 hours, or about 30 minutes to about 1 hour. Specific examples include about 30 minutes, about 1 hour, about 1.5 hours, about 2 hours, about 3 hours, and ranges between any two of these values (including their endpoints). Suitable mixing temperatures include about 20° C. to about 30° C., about 20° C. to about 26° C., or about 20° C. to about 23° C. Specific examples include about 20° C., about 22° C., about 26° C., about 30° C., and ranges between any two of these values (including their endpoints).

In some embodiments, to obtain the BF-PT solution, the bismuth ferrite solution and the lead titanate solution may be mixed. Prior to mixing BF and PT solutions, ethanolamine may be added as a stabilizing agent to the BF solution. Then, the PT solution may be added drop-wise to the BF solution. In some embodiments, the BF solution may be added drop-wise to the PT solution. The mixing of the two solutions may be performed for about 3 hours to about 15 hours, about 3 hours to about 12 hours, about 3 hours to about 9 hours, or about 3 hours to about 6 hours. Specific examples include about 3 hours, about 5 hours, about 8 hours, about 10 hours, about 12 hours, about 15 hours, and ranges between any two of these values (including their endpoints). Suitable mixing temperatures include about 50° C. to about 90° C., about 50° C. to about 70° C., about 50° C. to about 60° C., or about 0° C. to about 55° C. Specific examples include about 50° C., about 60° C., about 70° C., about 90° C., and ranges between any two of these values (including their endpoints).

In some embodiments, the PT layer 110 may be coated on the substrate by any method known in the art. Non-limiting examples include chemical solution deposition, chemical vapor deposition, physical vapor deposition, electrochemical deposition, dipping, spraying, and spin coating, or any combination thereof Once the desired coating thickness is obtained, pyrolysis of the coated layer may be performed at a temperature of about 300° C. to about 400° C., about 300° C. to about 375° C., or about 300° C. to about 350° C. Specific examples include about 300° C., about 360° C., about 375° C., about 400° C., and ranges between any two of these values (including their endpoints). The pyrolysis may be performed for a period of about 5 minutes to about 60 minutes, about 5 minutes to about 45 minutes, about 5 minutes to about 30 minutes, or about 5 minutes to about 15 minutes. Specific examples include about 5 minutes, about 15 minutes, about 30 minutes, about 45 minutes, about 60 minutes, and ranges between any two of these values (including their endpoints).

Once the substrate is coated with the PT layer, a BF-PT layer may be further coated on top of the PT layer. Coating of BF-PT layer may involve similar steps as recited above, such as chemical solution deposition, chemical vapor deposition, physical vapor deposition, electrochemical deposition, dipping, spraying, spin coating, or any combination thereof. The BF-PT coating is further subjected to pyrolysis step as described above. The final product obtained is subjected to drying and annealing at a temperature of about 600° C. to about 800° C., about 600° C. to about 700° C., or about 600° C. to about 650° C. Specific examples include about 600° C., about 650° C., about 700° C., about 800° C., and ranges between any two of these values (including their endpoints). The drying may be performed for a period of about 30 minutes to about 3 hours, about 30 minutes to about 2 hours, or about 30 minutes to about 1 hour. Specific examples include about 30 minutes, about 1 hour, about 1.5 hours, about 2 hours, about 3 hours, and ranges between any two of these values (including their endpoints).

### EXAMPLES

### Example 1

### Preparation of a Heterostructure Having BF-PT Composition (BiFeO₃)_{0.75}—(PbTiO₃)_{0.25}

Bismuth nitrate [Bi(NO₃)₃.5H₂O] (0.8004 grams) was dissolved in 4.5 mL of glacial acetic acid and stirred for 15 minutes. Ferric acetylacetonate [Fe(C₅H₇O₂)₃] (0.5416 grams) was dissolved in 5 mL of 2-methoxyethanol and stirred for 15 minutes. The bismuth nitrate solution and the ferric acetylacetonate solutions were mixed together followed by addition of 2 mL acetic anhydride and stirred for 3 hours at 60° C. to obtain a bismuth ferrite (BF) solution.

Lead acetate [(CH₃COO)₂Pb .3H₂O] (0.20865 grams) was dissolved in 5 mL of acetic acid and stirred for 1.5 hours. Titanium butoxide [Ti[O(CH₂)₃CH₃]₄] (0.1754 grams) was dissolved in 1 mL of acetylacetone. The lead acetate and titanium butoxide solutions were mixed with stirring for 1.5 hours at room temperature to obtain a lead titanate (PT) solution.

PT solution was added drop-wise to the BF solution stabilized with 1 mL of ethanolamine with constant stirring at 75° C. for 8 hours to obtain a 20 mL BF-PT solution.

The substrate was spin coated with 3 PbTiO₃ (PT) layers of resultant thickness 30 nanometers at a spin speed of 4000 rpm, followed by pyrolysis of PT layer at 360° C. for 10 minutes in air. Subsequently, the coated substrate was spin coated with BF-PT solution to obtain a film of thickness of 300 nanometers, followed by pyrolysis of BF-PT layer at 360° C. for 10 minutes in air. The resulting product was annealed in air for 1 hour at 765° C. to obtain the hetero structure.

### Example 2

### Preparation of a Heterostructure Having BF-PT Composition (BiFeO₃)_{0.70}—(PbTiO₃)_{0.30}

Bismuth nitrate [Bi(NO₃)₃.5H₂O] (0.7470 grams) was dissolved in 4.5 mL of glacial acetic acid and stirred for 15 minutes. Ferric acetylacetonate [Fe(C₅H₇O₂)₃] (0.5097 grams) was dissolved in 5 mL of 2-methoxyethanol and stirred for 15 minutes. The bismuth nitrate solution and the ferric acetylacetonate solutions were mixed together followed by addition of 2 mL acetic anhydride and stirred for 3 hours at 60° C. to obtain a bismuth ferrite (BF) solution.

Lead acetate [(CH₃COO)₂Pb.3H₂O] (0.2504 grams) was dissolved in 5 mL of acetic acid and stirred for 1.5 hours. Titanium butoxide [Ti[O(CH₂)₃CH₃]₄] (0.2105 grams) was dissolved in 1 mL of acetylacetone. The lead acetate and titanium butoxide solutions were mixed with stirring for 1.5 hours at room temperature to obtain a lead titanate (PT) solution.

PT solution was added drop-wise to the BF solution stabilized with 1 mL of ethanolamine with constant stirring at 75° C. for 8 hours to obtain a 20 mL BF-PT solution.

The substrate was spin coated with 3 PbTiO₃ (PT) layers of resultant thickness 30 nanometers at a spin speed of 4000 rpm, followed by pyrolysis of PT layer at 360° C. for 10 minutes in air. Subsequently, the coated substrate was spin coated with BF-PT solution to obtain a film of thickness of 300 nanometers, followed by pyrolysis of BF-PT layer at 360° C. for 10 minutes in air. The resulting product was annealed in air for 1 hour at 750° C. to obtain the hetero structure.

### Example 3

### Preparation of a Heterostructure Having BF-PT Composition (BiFeO₃)_{0.65}—(PbTiO₃)_{0.35}

Bismuth nitrate [Bi(NO₃)₃.5H₂O] (0.6937 grams) was dissolved in 4.5 mL of glacial acetic acid and stirred for 15 minutes. Ferric acetylacetonate [Fe(C₅H₇O₂)₃] (0.4733 grams) was dissolved in 5 mL of 2-methoxyethanol and stirred for 15 minutes. The bismuth nitrate solution and the ferric acetylacetonate solutions were mixed together followed by addition of 2 mL acetic anhydride and stirred for 3 hours at 60° C. to obtain a bismuth ferrite (BF) solution.

Lead acetate [(CH₃COO)₂Pb.3H₂O] (0.2921 grams) was dissolved in 5 mL of acetic acid and stirred for 1.5 hours. Titanium butoxide [Ti[O(CH₂)₃CH₃]₄] (0.2456 grams) was dissolved in 1 mL of acetylacetone. The lead acetate and titanium butoxide solutions were mixed with stirring for 1.5 hours at room temperature to obtain a lead titanate (PT) solution.

PT solution was added drop-wise to the BF solution stabilized with 1 mL of ethanolamine with constant stirring at 75° C. for 8 hours to obtain a 20 mL BF-PT solution.

The substrate was spin coated with 3 PbTiO₃ (PT) layers of resultant thickness 30 nanometers at a spin speed of 4000 rpm, followed by pyrolysis of PT layer at 360° C. for 10 minutes in air. Subsequently, the coated substrate was spin coated with BF-PT solution to obtain a film of thickness of 300 nanometers, followed by pyrolysis of BF-PT layer at 360° C. for 10 minutes in air. The resulting product was annealed in air for 1 hour at 720° C. to obtain the heterostructure.

### Example 4

### Surface Morphology and cross Sectional Scanning Electron Microscopic Studies

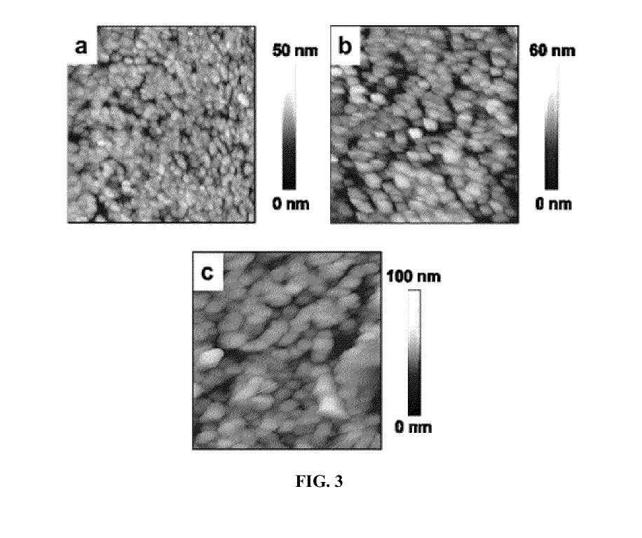

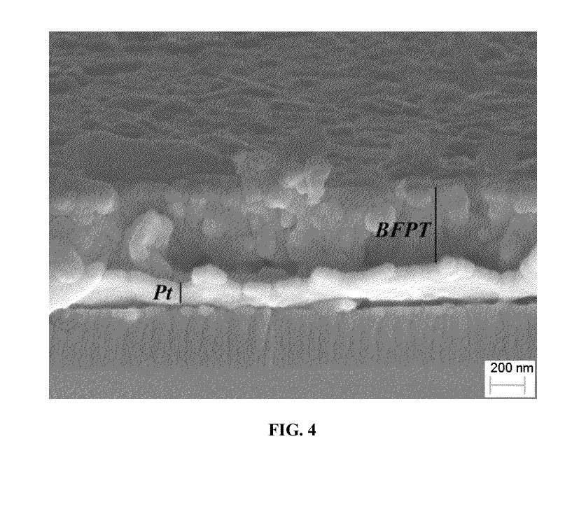

The topological characterization of the films was performed using atomic force microscopy (Agilent, PICO SPM 3000) in tapping mode. The average grain size and roughness of the films increased, as the x increased from x=0.35 to x=0.25, owing to slightly higher processing temperatures (FIG. 3). A Zeiss Supra 40VP Scanning electron microscope was employed to study the cross sectional structure of the films (FIG. 4). All the films observed were dense, crack free, with no preferred orientation of the grains. Further, energy dispersive X-Ray analysis (EDAX) analysis revealed the compositional homogeneity of the samples.

### Example 5

### X-Ray Diffraction Studies

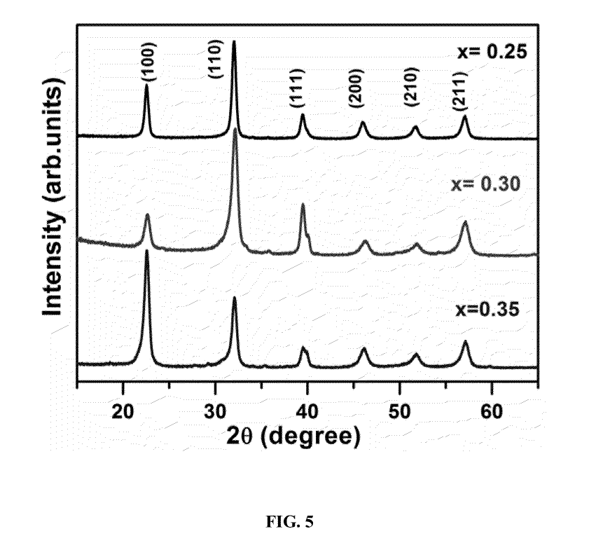

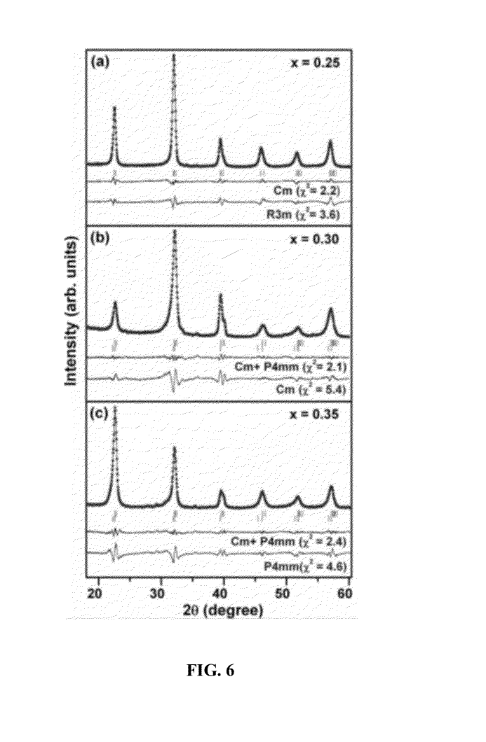

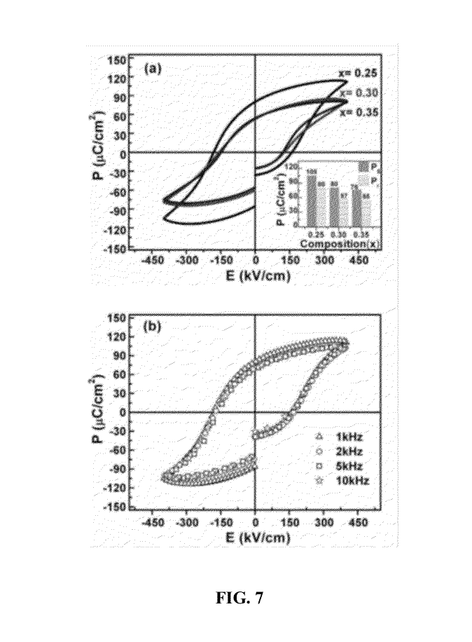

Glancing incidence X-ray diffraction (GIXRD) patterns of the BF-xPT films of three different compositions (x=0.25, 0.30 and 0.35) were obtained using a PANalytical X'Pert PRO MRD diffractometer employing CuK_{α} radiation (λ=1.54056 Å) and a goniometer resolution of 0.0001 as shown in FIG. 5. All the peaks in the spectra were indexed according to the pseudocubic indices (ICDD Card No: 01-074-2499) and suggested phase-pure nature of the films. All the peaks showed remarkable broadening which can be attributed to smaller grain sizes (ranging from 50-200 nanometers). The broadening of peaks may also be due to overlap of multitude of reflections giving rise to perceived broadness. Structural refinement of BF-xPT films using Lebail technique revealed that the crystal structure at x=0.25 was monoclinic (Cm), and was in contrast to the rhombohedral (R3m) structure seen in the bulk solution. At x=0.30 and x=0.35, BF-xPT films displayed both monoclinic (Cm) phase and tetragonal (P4mm) phase (FIG. 6).

### Example 6

### Electrical Characterization Studies

Platinum top electrodes of diameter 0.2 mm were sputtered on to the BF-xPT films through a shadow mask. The dielectric and ferroelectric properties of the films were measured using Agilent 4294A Impedance analyzer and Radiant Precision Premier II ferroelectric tester respectively. FIG. 7A shows the room temperature ferroelectric hysteresis loops for the BF-xPT films (x=0.25, 0.30 and 0.35). The measurements were made using a bipolar pulse at 1 kHz frequency. The films of composition x=0.25 displayed very high remnant polarization (Pᵣ) with values as high as about 80 μC/cm², while films of composition x=0.30 and 0.35 showed Pᵣ values of about 57 and about 55 μC/cm², respectively, at 12 volts. FIG. 7B shows the frequency dependent ferroelectric response of the film with x=0.25, from 1 kHz-10 kHz. Pᵣ values did not change considerably over the entire frequency range, suggesting that ferroelectricity in these films was of intrinsic nature. Inset in right bottom corner of the FIG. 7A show the Pᵣ and Pₛ values as a function of composition x. Films with x=0.30 and x=0.35 exhibited slightly smaller Pᵣ values due to the reduced phase fraction of the monoclinic phase coexisting with the tetragonal phase.

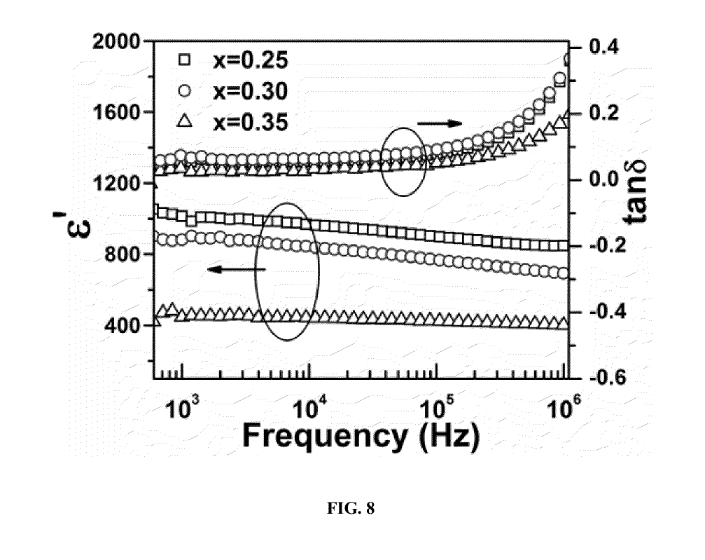

FIG. 8 shows the variation of room temperature dielectric constant and dielectric loss with frequency for the BF-xPT films from 500 Hz-1 MHz. The real part of dielectric constant (ε′) remained fairly constant for all the samples with BF-_{0.25}PT and BF-_{0.30}PT, showing higher dielectric constant values of ˜1000 and ˜880. However, BF-0.₃₅PT sample showed a dielectric constant value of ˜400 at lkHz. The dielectric loss tangent, tan δ, values were 0.09 for BF-_{0.25}PT, 0.07 for BF-_{0.30}PT and 0.04for BF-_{0.35}PT. The loss tangent showed a Debye-like relaxation behavior beyond 105 Hz which may be due to short range motion of dipoles.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (example, bodies of the appended claims) are generally intended as “open” terms (example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (example, “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (example, “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of making a heterostructure, the method comprising:
mixing a solution of a bismuth salt with a solution of a ferric acetylacetonate to obtain a bismuth ferrite solution;
mixing a solution of a lead salt with a solution of a titanium compound to obtain a lead titanate solution;
mixing the bismuth ferrite solution and the lead titanate solution to obtain bismuth ferrite-lead titanate solution (BF-PT solution);
contacting a substrate with the lead titanate solution to obtain a lead titanate coated substrate; and
contacting the lead titanate coated substrate with the BF-PT solution to obtain the hetero structure.

2. The method of claim 1, wherein contacting the substrate with the lead titanate solution results in a substrate that is partially or completely coated with a lead titanate coating of a thickness of about 25 nanometers to about 40 nanometers.

3. (canceled)

4. The method of claim 1, wherein mixing the bismuth ferrite solution and the lead titanate solution is performed at a temperature of about 50° C. to about 90° C.

5. The method of claim 1, wherein mixing the solution of a bismuth salt with the solution of ferric acetylacetonate comprises mixing the solution of ferric acetylacetonate with a solution of a bismuth salt selected from the group consisting of bismuth nitrate, bismuth chloride, bismuth sulfate, bismuth phosphate, bismuth acetate, bismuth citrate, bismuth alkoxide, and any combination thereof

6. The method of claim 1, wherein mixing the solution of a bismuth salt with the solution of ferric acetylacetonate comprises mixing the solution of ferric acetylacetonate with the bismuth salt dissolved in acetic acid, formic acid, oxalic acid, trichloroacetic acid, 2-methoxyethanol, or any combination thereof.

7. The method of claim 1, wherein mixing the solution of a bismuth salt with the solution of ferric acetylacetonate comprises mixing the solution of bismuth salt with ferric acetylacetonate dissolved in 2-methoxyethanol, an ethylene glycol alkyl ether, an ethylene glycol dialkyl ether, an ethylene glycol ester, or any combination thereof.

8. The method of claim 1, wherein mixing the bismuth salt solution with the ferric acetylacetonate solution comprises mixing the bismuth salt solution and the ferric acetylacetonate solution in the presence of an acid anhydride.

9. (canceled)

10. The method of claim 1, wherein mixing the bismuth salt solution with the ferric acetylacetonate solution is performed for about 1 hour to about 6 hours and at a temperature of about 40° C. to about 70° C.

11. (canceled)

12. The method of claim 1, wherein mixing the solution of a lead salt with the solution of a titanium compound comprises mixing the solution of the titanium compound with the solution of a the lead salt selected from the group consisting of lead acetate, lead phosphate, lead sulfate, lead nitrate, and any combination thereof

13. The method of claim 1, wherein mixing the solution of a lead salt with the solution of a titanium compound comprises mixing the solution of titanium compound with the lead salt dissolved in acetic acid, formic acid, oxalic acid, trichloroacetic acid, citric acid, or any combination thereof.

14. The method of claim 1, wherein mixing the solution of a lead salt with the solution of a titanium compound comprises mixing the solution of lead salt with a solution of titanium butoxide or a titanium alkoxide.

15. The method of claim 1, wherein mixing the solution of a lead salt with the solution of a titanium compound comprises mixing the solution of lead salt with the titanium compound dissolved in acetylacetone.

16. The method of claim 1, wherein mixing the lead salt solution and the titanium compound solution is performed for about 30 minutes to about 3 hours and at a temperature of about 20° C. to about 30° C.

17. (canceled)

18. The method of claim 1, wherein mixing the bismuth ferrite solution and the lead titanate solution comprises adding ethanolamine to the bismuth ferrite solution prior to mixing with the lead titanate solution.

19. The method of claim 1, wherein mixing the bismuth ferrite solution and the lead titanate solution is performed for about 3 hours to about 15 hours.

20. The method of claim 1, wherein contacting the substrate with the lead titanate solution comprises contacting a metal coated silicon substrate or a metal coated quartz substrate with the lead titanate solution.

21-22. (canceled)

23. The method of claim 20, wherein contacting the substrate with lead titanate solution further comprises pyrolysis of the coated substrate at a temperature of about 300° C. to about 400° C. for a period of about 5 minutes to about 60 minutes.

24. (canceled)

25. The method of claim 1, wherein contacting the lead titanate coated substrate with the BF-PT solution further comprises pyrolysis of the coated substrate at a temperature of about 300° C. to about 400° C. for a period of about 5 minutes to about 60 minutes.

26. The method of claim 25, further comprising drying the coated substrate at a temperature of about 600° C. to about 800° C. for a period of about 30 minutes to about 3 hours.

27-31. (canceled)

32. The method of claim 31, wherein contacting the lead titanate coated substrate with the BF-PT solution results in the heterostructure comprising a BF-PT coating having a composition (BiFeO₃)₁₋ₓ—(PbTiO₃)ₓ, wherein 0.25≦x≦0.35.

33. A heterostructure comprising:
a metal coated silicon substrate;
a first ferroelectric layer comprising lead titanate, wherein the first ferroelectric layer is in contact with the metal coated silicon substrate; and
a second ferroelectric layer comprising (BiFeO₃)₁₋ₓ—(PbTiO₃)ₓ, wherein 0.25≦x≦0.35, wherein the second ferroelectric layer is in contact with the first ferroelectric layer, and wherein the thickness of the first ferroelectric layer is 30 nanometers, and the heterostructure has a dielectric constant of about 400 to about 1000 when measured at a temperature of about 20° C. to about 30° C.

34. The heterostructure of claim 33, wherein the second ferroelectric layer comprises a tetragonal crystal structure, a monoclinic crystal structure, or any combination thereof, and has a grain size having an average diameter of about 50 nanometers to about 200 nanometers.

35. (canceled)

36. The heterostructure of claim 33, wherein the second ferroelectric layer partially or completely exhibits a monoclinic crystal structure.

37. The heterostructure of claim 33, wherein the thickness of the second ferroelectric layer is about 300 nanometers to about 400 nanometers.

38. The heterostructure of claim 33, wherein the heterostructure has a remnant polarization of about 50 μC/cm² to about 90 μC/cm².

39-41. (canceled)
